(19) United States
(12) Patent Application Publication
(10) Pub. No.: US 2014/0172443 A1
(43) Pub. Date: Jun. 19, 2014

(54) Method and Apparatus for Preventing Fraud in Medicare, Medicaid, and Other Industries

(71) Applicants: Denis M. Long, San Antonio, TX (US); Lisa Jean Long, San Antonio, TX (US)

(72) Inventors: Denis M. Long, San Antonio, TX (US); Lisa Jean Long, San Antonio, TX (US)

(21) Appl. No.: 14/104,679

(22) Filed: Dec. 12, 2013

Related U.S. Application Data
(60) Provisional application No. 61/736,829, filed on Dec. 13, 2012.

(51) Int. Cl. G06Q 50/22; G06Q 30/00

(52) U.S. Cl. CPC G06Q 50/22; G06Q 30/0185
USPC 705/2

(57) ABSTRACT

Methods and systems for preventing fraud in a remote workforce environment are disclosed, including an apparatus, comprising processor(s), system memory, non-transitory memory unit(s), and verification code; verifying if ECV is permitted to deliver a product and/or perform a service; if not, then notifying a supervisor; verifying if recipient of the product and/or service is correct; if not, then notifying the supervisor; and verifying if location and/or time of delivery of the product and/or performance of the service is correct; if not, then notifying the supervisor; and if determined that: the ECV is permitted to deliver the product and/or perform the service, the recipient of the product and/or service is correct, and the location and/or time of delivery of the product and/or performance of the service is correct, then notifying the ECV to proceed with the delivery of the product and/or performance of the service. Other embodiments are described and claimed.

### I. CROSS REFERENCE TO RELATED APPLICATIONS

This application claims the benefit of the filing date of U.S. Provisional Patent Application Ser. No. 61/736,829, filed on Dec. 13, 2012, entitled “Method and Apparatus for Preventing Fraud in Medicare, Medicaid, and Other Industries,” the entire disclosure of which is hereby incorporated by reference into the present disclosure.

### II. BACKGROUND

A Home HealthCare Agency (HHA) is licensed by the State in which it operates. If the HHA provides services to Medicare recipients, the HHA is also licensed by the Federal Government. State licensing requirements may differ across each of the fifty states, whereas the Federal Government's Medicare and Medicaid regulations apply uniformly across all states. The State and Federal Government's licensing requirements and regulations may require that the HHA perform and document numerous checks at various frequencies (i.e. monthly or annually) in order to satisfy the conditions in which the HHA may participate in the State and Federal programs. These State and Federal Government “safe guards” are put in place in an attempt to prevent fraud and abuse, but unfortunately, the attempts are continuously circumvented by individuals who choose to defraud the government. The intent of the required government agency checks is to prevent nonqualified individuals from working for HHAs and directly interacting with potentially vulnerable program participants. In order to comply, several items such as nursing license, driver's license, insurance, misconduct registry, State and Federal Office of Inspector General's exclusion lists, State and National criminal backgrounds, and/or other similar registries and databases are routinely monitored by HHA staff to ensure that individuals who falsely represent themselves or are barred from participating are not on the HHA's payroll. Additionally, the HHA is also responsible for ensuring that the patient is eligible for services that are to be performed and eventually billed to and paid by either Medicare or Medicaid. Along with verifying patient eligibility, the HHA is also held accountable for ensuring that the proper employee is performing the service. The HHA may be audited by a multitude of agencies and may be cited, fined, and/or required to payback large sums of money due to unjustified billing of Medicare, Medicaid, or insurance. In extreme cases, the HHA may even be forced to surrender its license to operate in the state or have its privilege to participate in Medicare and Medicaid revoked.

A need exists, especially in the HHA industry, for an apparatus and method for preventing nurse imposters, preventing illegal billing of Medicare, Medicaid, or other insurers, and preventing patients from illegally obtaining services by using someone else's Medicare, Medicaid, or insurance number. An example of a nurse imposter is the situation where a Registered Nurse allows someone else to perform his or her nursing duties and the responsible HHA is not aware of the fraudulent action. Illegal billing of Medicare, Medicaid, or other insurer may occur when for example a nurse submits official notes stating they have performed visits at a patient's home when in fact that was not the case. This situation is very difficult to discover and prove unless for example, the patient is actually admitted into a hospital at the same time the nurse states they performed a visit to the patient's home. Finally, services may be illegally obtained when an insurance card is fraudulently used by someone other than the insurance beneficiary. This is possible since there typically are not any photographic representations of the insured on the insurance card. The responsibility and burden to report and investigate these and other similar situations falls on the HHA responsible for the employee or patient.

The embodiment or embodiments described herein solve these problems and others by proposing a new method and apparatus for preventing Medicare, Medicaid, or insurance fraud by proactively validating at the time and place of service that the HHA nurse or employee is qualified and approved to perform the service, that the patient is eligible for the service, and that both the HHA nurse or employee and the patient are at the same place and at the same time when the service is performed.

### III. SUMMARY

In one respect, disclosed is an apparatus for preventing fraud in a remote workforce environment, the apparatus comprising: one or more processors; system memory coupled to the one or more processors; one or more non-transitory memory units coupled to the one or more processors; and verification code stored on the one or more non-transitory memory units that when executed by the one or more processors are configured to perform a method, comprising: verifying if an ECV is permitted to deliver a product and/or perform a service; and if it is determined that the ECV is not permitted to deliver the product and/or perform the service, then notifying a supervisor of the ECV that the ECV is not permitted to deliver the product and/or perform the service; and verifying if recipient of the product and/or service is correct; and if it is determined that the recipient of the product and/or service is not correct, then notifying the supervisor of the ECV that the recipient of the product and/or service is not correct.

In another respect, disclosed is an apparatus for preventing fraud in a remote workforce environment, the apparatus comprising: one or more processors; system memory coupled to the one or more processors; one or more non-transitory memory units coupled to the one or more processors; and verification code stored on the one or more non-transitory memory units that when executed by the one or more processors are configured to perform a method, comprising: verifying if an ECV is permitted to deliver a product and/or perform a service; and if it is determined that the ECV is not permitted to deliver the product and/or perform the service, then notifying a supervisor of the ECV that the ECV is not permitted to deliver the product and/or perform the service; verifying if recipient of the product and/or service is correct; and if it is determined that the recipient of the product and/or service is not correct, then notifying the supervisor of the ECV that the recipient of the product and/or service is not correct; and verifying if location and/or time of delivery of the product and/or performance of the service is correct; and if it is determined that the location and/or time of delivery of the product and/or performance of the service is not correct, then notifying the supervisor of the ECV that the location and/or time of delivery of the product and/or performance of the service is not correct; and if it is determined that: the ECV is permitted to deliver the product and/or perform the service, the recipient of the product and/or service is correct, and the location and/or time of delivery of the product and/or performance of the service is correct, then notifying the ECV to proceed with the delivery of the product and/or performance of the service.

In another respect, disclosed is a method for preventing fraud in a remote workforce environment, the method comprising: an apparatus, which includes one or more processors, system memory coupled to the one or more processors, one or more non-transitory memory units coupled to the one or more processors, and verification code stored on the one or more non-transitory memory units; verifying if an ECV is permitted to deliver a product and/or perform a service; and if it is determined that the ECV is not permitted to deliver the product and/or perform the service, then notifying a supervisor of the ECV that the ECV is not permitted to deliver the product and/or perform the service; and verifying if recipient of the product and/or service is correct; and if it is determined that the recipient of the product and/or service is not correct, then notifying the supervisor of the ECV that the recipient of the product and/or service is not correct.

In yet another respect, disclosed is a method for preventing fraud in a remote workforce environment, the method comprising: an apparatus, which includes one or more processors, system memory coupled to the one or more processors, one or more non-transitory memory units coupled to the one or more processors, and verification code stored on the one or more non-transitory memory units; verifying if an ECV is permitted to deliver a product and/or perform a service; and if it is determined that the ECV is not permitted to deliver the product and/or perform the service, then notifying a supervisor of the ECV that the ECV is not permitted to deliver the product and/or perform the service; verifying if recipient of the product and/or service is correct; and if it is determined that the recipient of the product and/or service is not correct, then notifying the supervisor of the ECV that the recipient of the product and/or service is not correct; and verifying if location and/or time of delivery of the product and/or performance of the service is correct; and if it is determined that the location and/or time of delivery of the product and/or performance of the service is not correct, then notifying the supervisor of the ECV that the location and/or time of delivery of the product and/or performance of the service is not correct; and if it is determined that: the ECV is permitted to deliver the product and/or perform the service, the recipient of the product and/or service is correct, and the location and/or time of delivery of the product and/or performance of the service is correct, then notifying the ECV to proceed with the delivery of the product and/or performance of the service.

Numerous additional embodiments are also possible.

### IV. BRIEF DESCRIPTION OF THE DRAWINGS

Other objects and advantages of the invention may become apparent upon reading the detailed description and upon reference to the accompanying drawings.

FIG. 1 is a block diagram illustrating an apparatus for preventing fraud, in accordance with some embodiments.

FIG. 2 is a block diagram illustrating an apparatus for preventing fraud, in accordance with some embodiments.

FIG. 3 is a block diagram illustrating an apparatus for preventing fraud, in accordance with some embodiments.

FIG. 4 is a block diagram illustrating a method for preventing fraud in a remote workforce environment, in accordance with some embodiments.

While the invention is subject to various modifications and alternative forms, specific embodiments thereof are shown by way of example in the drawings and the accompanying detailed description. It should be understood, however, that the drawings and detailed description are not intended to limit the invention to the particular embodiments. This disclosure is instead intended to cover all modifications, equivalents, and alternatives falling within the scope of the present invention as defined by the appended claims.

### V. DETAILED DESCRIPTION

One or more embodiments of the invention are described below. It should be noted that these and any other embodiments are exemplary and are intended to be illustrative of the invention rather than limiting. While the invention is widely applicable to different types of systems, it is impossible to include all of the possible embodiments and contexts of the invention in this disclosure. Upon reading this disclosure, many alternative embodiments of the present invention will be apparent to persons of ordinary skill in the art.

In the Home HealthCare industry, employee nurses and other individuals are out in the field, i.e. a patient's home or nursing facility, performing a variety of services. Currently, an employee nurse of an HHA may be able to defraud their employer by reporting that they delivered a particular service to a patient when in fact they did not. They may also deliver a particular service to a patient that was not eligible for that service and it is not until much later that such fraud is brought to light. This sort of fraud may all but be eliminated if at the point of service and in real-time, the HHA employee, the patient, and location are first verified prior to the performance of the service. If the nurse or other individual performs the service without having first been verified, the HHA may opt to not bill Medicare, Medicaid, or other insurance company. The HHA would thus be in a stronger position to withhold payment from the nurse or individual that performed the service since the verification was not accomplished prior to the delivery of service. The multi-faceted verification prevents insurances from being improperly billed while simultaneously protecting the HHA from imposter employees. Verification also has an added benefit that the HHA Patient has some assurance that the HHA Employee is actually qualified to deliver the product or service and that it is not being performed by an ineligible individual or imposter employee.

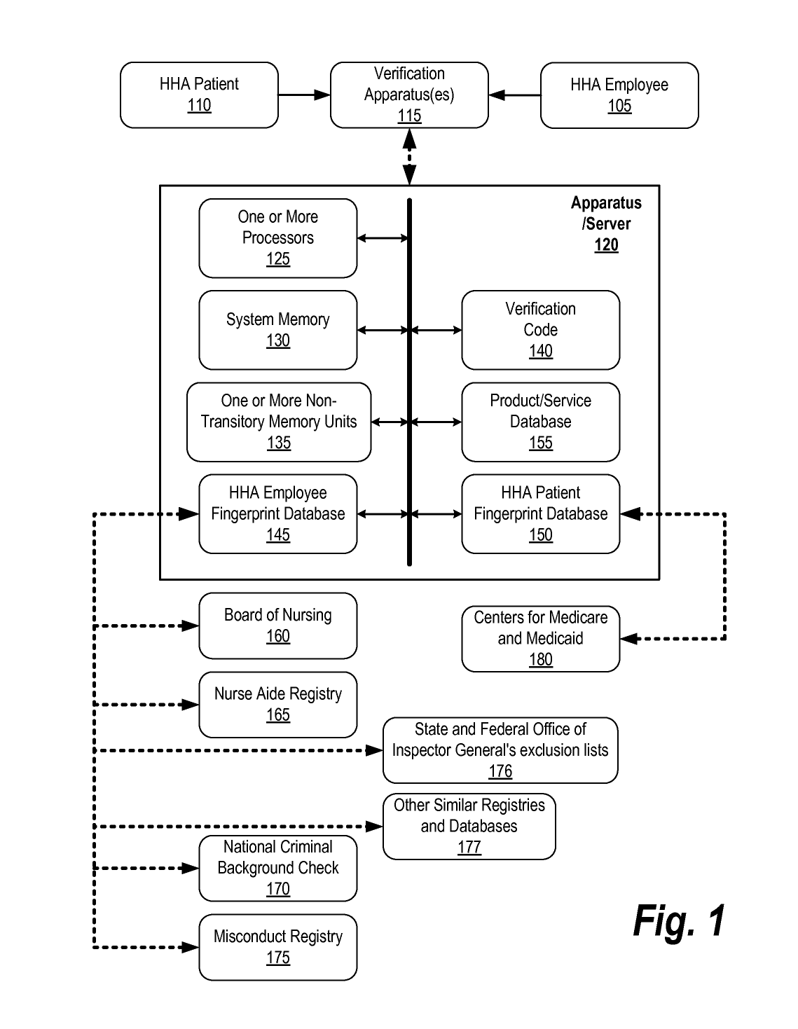

FIG. 1 is a block diagram illustrating an apparatus for preventing fraud, in accordance with some embodiments.

In some embodiments, an employee of the HHA 105 is out in the field delivering services to a patient 110. In order to reduce fraud, the HHA may issue to the employee a verification apparatus 115 that is used in verifying the HHA employee 105, verifying the HHA patient 110, verifying the service to be performed, and verifying the location of the service. The verification apparatus 115 then communicates with an apparatus/server 120 comprising one or more processors 125, system memory 130, one or more non-transitory memory units 135, and verification code 140. The apparatus/server 120 may also comprise an HHA Employee Fingerprint Database 145, an HHA Patient Fingerprint Database 150, and a Product/Service Database 155. In alternative embodiments, the HHA Employee Fingerprint Database 145, the HHA Patient Fingerprint Database 150, and the Product/Service Database 155 are remotely located from the apparatus/server 120. Communication between the verification apparatus 115 and the apparatus/server 120 may occur over any suitable wireless and/or wired network such as, for example, the Internet, an intranet, a wireless area network, a local area network, a cellular network, and/or the like. The verification apparatus 115 may comprise one or more smart phones or other computing devices, such as desktop computers, laptop computers, or tablets.

When the HHA employee 105 arrives to the location of the HHA patient 110, the HHA employee 105 will use the verification apparatus to capture the fingerprint of the HHA employee 105 and the fingerprint of the HHA patient 110. The verification apparatus may capture the fingerprint data using an integrated or non-integrated camera or fingerprint reader. The location of the verification apparatus 115, and hence the location of where the service is to be performed, may be determined in a number of different ways such as with GPS signals technology, assisted GPS technology, and router location lookup tables. The verification apparatus 115 may have a GPS chip integrated within it which is capable of determining its location using the GPS satellites. The verification apparatus 115 may also use the GPS signals in combination with the mobile phone tower network in determining the location of the verification apparatus 115. This location determination is referred to as assisted GPS technology. If the verification apparatus 115 has integrated Wi-Fi and is within range of a router whose location has been mapped and recorded, the location of the verification apparatus 115 may also be determined in this fashion.

The verification apparatus 115 then communicates to the apparatus/server 120, the fingerprint data, the location of where the service is to be performed, and the type of service to be performed. The verification code then accomplishes a number of different verifications.

The verification code looks up the HHA Employee 105 in the HHA Employee

Fingerprint Database 145 to verify that the individual at the location of the patient is actually the HHA Employee 105 and that the HHA Employee 105 is eligible to perform the service. The HHA Employee's 105 eligibility to perform the service is verified by checking with the Board of Nursing 160, the Nurse Aide Registry 165, the National Criminal Background Check 170, the Misconduct Registry 175, State and Federal Office of Inspector General's exclusion lists 176, and/or other similar registries and databases 177, such as licensing status, CPR qualification status, driver's license validity, minimum automobile insurance, and/or the like, depending on the type of employee being verified. In some embodiments, the HHA Employee Fingerprint Database 145 comprises data with regards to employee eligibility by being regularly updated with data from the Board of Nursing 160, the Nurse Aide Registry 165, the National Criminal Background Check 170, the Misconduct Registry 175, State and Federal Office of Inspector General's exclusion lists 176, and/or other similar registries and databases 177, such as licensing status, CPR qualification status, driver's license validity, minimum automobile insurance, and/or the like. With regards to the State Office of Inspector General's exclusion list, an HHA in Texas, for example, must check the exclusion list monthly. The Texas list may be accessed via the web at oig.hhse.state.tx.us. Other states require different frequencies for checking. With regards to the Federal Office of Inspector General's exclusion list, an HHA must check the list semi-annually or annually. The Federal list is accessible via the web at www.exclusions.oig.hhs.gov. The databases may be either updated manually by personnel or updated automatically by computer scripts or other program code.

The verification code looks up the HHA Patient 110 in the HHA Patient Fingerprint Database 150 to verify that the individual at the location of the employee is actually the HHA Patient 110 and that the HHA Patient 110 is eligible to receive the service. The HHA Patient's 110 eligibility to receive the service is verified by checking with the Centers for Medicare and Medicaid 180. In some embodiments, the HHA Patient Fingerprint Database 150 comprises data with regards to patient eligibility by being regularly updated with data from the Centers for Medicare and Medicaid 180.

In addition to verifying the employee and patient, the verification code also verifies that the service and the location of the service are allowed by verifying with a product/service database 155. In some embodiments, this information is integrated with the Patient Fingerprint Database 150. If all the verifications check out, the HHA Employee 105 may then receive a notification that they may proceed with the performance of the product or service. If the HHA Employee 105 proceeds to perform the product or service without prior verification, the HHA may withhold payment for that particular product or service. Additionally, if the verification fails, the HHA may be notified, thus enabling the HHA to investigate or contact legal authorities. Doing so may result in the apprehension of the perpetrator of the potential fraudulent theft of Medicare, Medicaid, or private insurance monies.

In other embodiments, verification is accomplished using facial recognition. In such an embodiment, the patient and employee databases have the facial data necessary to make a verification from a face. A facial image is captured and then verified with the appropriate databases prior to the performance of products or services. Other means for verification are also possible. Additionally, verification may be accomplished by one or more verification means. Thus making it more difficult for an employee or patient to cheat the verification process.

Some embodiments described herein relate to a computer storage product with one or more non-transitory memory units having instructions or computer code thereon for performing various computer-implemented operations. The one or more memory units are non-transitory in the sense that they do not include transitory propagating signals per se (e.g., a propagating electromagnetic wave carrying information on a transmission medium such as space or a cable). The one or more memory units and computer code (also can be referred to as code) may be those designed and constructed for the specific purpose or purposes. Examples of one or more memory units include, but are not limited to: magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM), and Random-Access Memory (RAM) devices.

Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using Java, C++, or other programming languages (e.g., object-oriented programming languages) and development tools. Additional examples of computer code include, but are not limited to, control signals, encrypted code, and compressed code.

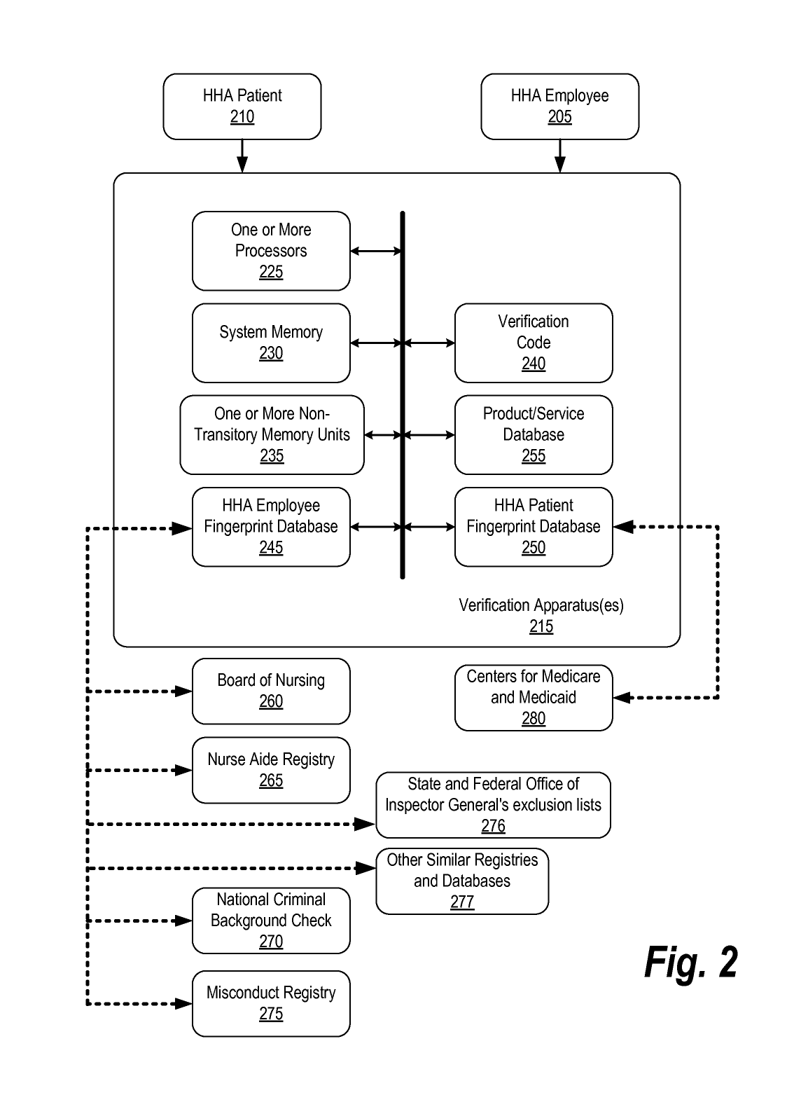

FIG. 2 is a block diagram illustrating an apparatus for preventing fraud, in accordance with some embodiments.

In some embodiments, a Medicare, Medicaid, and/or other insurance industry fraud prevention apparatus comprises the integration of the verification apparatus 115 with the server 120. In this embodiment, the verification apparatus 215 comprises one or more processors 225, system memory 230, one or more non-transitory memory units 235, verification code 240, an HHA Employee Fingerprint Database 245, an HHA Patient Fingerprint Database 250, and a Product/Service Database 255. In such an embodiment, the most up to date versions of the HHA Employee Fingerprint Database 245, the HHA Patient Fingerprint Database 250, the Product/Service Database 255, and the Verification Code 240 are either pushed or automatically downloaded in real-time as the verification process is undertaken. This is accomplished by checking with relevant databases such as the Board of Nursing 260, the Nurse Aide Registry 265, the National Criminal Background Check 270, the Misconduct Registry 275, the Centers for Medicare and Medicaid 280, State and Federal Office of Inspector General's exclusion lists 276, and/or other similar registries and databases 277. In real-time signifies that when a verification is undertaken, the verification will have the most up-to-date information available from the various databases and registries.

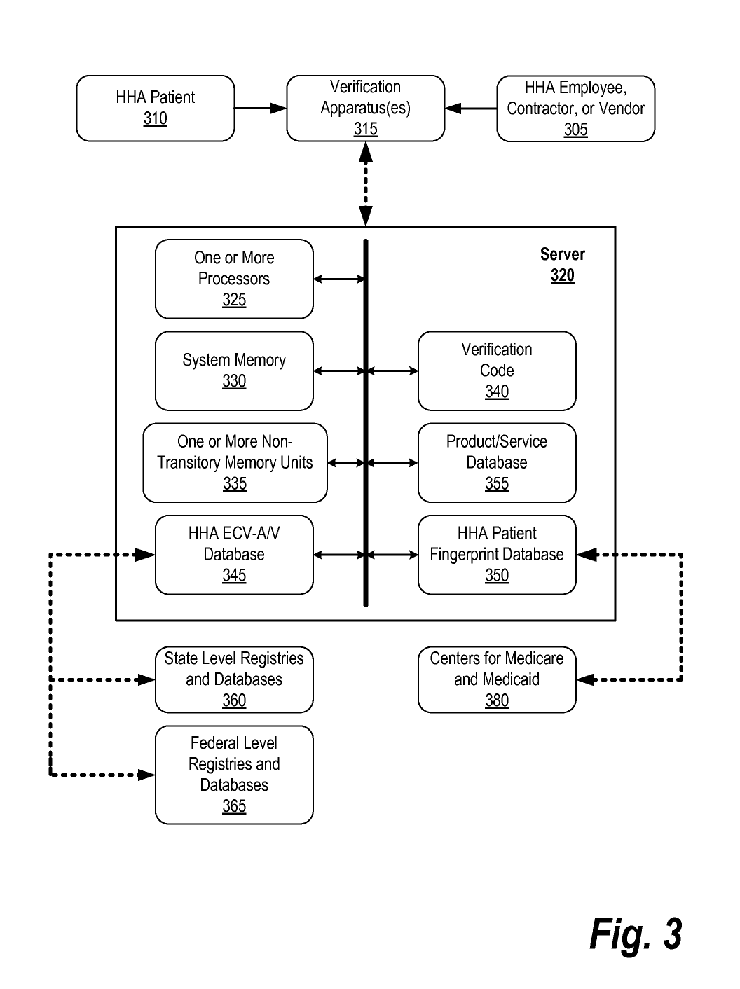

FIG. 3 is a block diagram illustrating an apparatus for preventing fraud, in accordance with some embodiments.

In some embodiments, an employee, contractor, or vendor (ECV) of the HHA 305 is out in the field delivering services to a patient 310. In order to reduce fraud, the HHA may issue to the ECV an apparatus 315 that is used in verifying the HHA ECV 305, verifying the HHA patient 310, verifying the service to be performed, and verifying the location of the service. The apparatus 315 then communicates with a server 320 comprising one or more processors 325, system memory 330, one or more non-transitory memory units 335, and verification code 340. The server 320 may also comprise an HHA Employee, Contractor, Vendor-Authentication/Verification (ECV-A/V) Database 345, an HHA Patient Fingerprint Database 350, and a Product/Service Database 355. In alternative embodiments, the HHA (ECV-A/V) Database 345, the HHA Patient Fingerprint Database 350, and the Product/Service Database 355 are remotely located from the server 320. Communication between the apparatus 315 and the server 320 may occur over any suitable wireless and/or wired network such as, for example, the Internet, an intranet, a wireless area network, a local area network, a cellular network, and/or the like. The apparatus 315 may comprise one or more smart phones or other computing devices, such as desktop computers, laptop computers, or tablets.

When the HHA ECV 305 arrives to the location of the HHA patient 310, the HHA ECV 305 will use the apparatus to capture the fingerprint of the HHA ECV 305 and the fingerprint of the HHA patient 310. The apparatus may capture the fingerprint data using an integrated or non-integrated camera or fingerprint reader. The location of the apparatus 315, and hence the location of where the service is to be performed, may be determined in a number of different ways such as with GPS signals technology, assisted GPS technology, and router location lookup tables. The apparatus 315 may have a GPS chip integrated within it which is capable of determining its location using the GPS satellites. The apparatus 315 may also use the GPS signals in combination with the mobile phone tower network in determining the location of the apparatus 315. This location determination is referred to as assisted GPS technology. If the apparatus 315 has integrated Wi-Fi and is within range of a router whose location has been mapped and recorded, the location of the apparatus 315 may also be determined in the fashion.

The apparatus 315 then communicates to the server 320, the fingerprint data, the location of where the service is to be performed, and the type of service to be performed. The verification code then accomplishes a number of different verifications.

The verification code looks up the HHA ECV 305 in the HHA ECV-A/V Database 345 to verify that the individual at the location of the patient is actually the HHA ECV 305 and that the HHA ECV 305 is eligible to perform the service. The HHA ECV's 305 eligibility to perform the service is verified by checking with State Level Registries and Databases 360 and Federal Level Registries and Databases 365, depending on the type of ECV being verified. The State Level Registries and Databases 360 comprise the Board of Nursing, the Nurse Aide Registry, the State Criminal Background Check, the State Office of Inspector General's exclusion list, the Misconduct Registry, and/or other similar local registries and databases. The Federal Level Registries and Databases 365 comprise the National Criminal Background Check, the Federal Office of Inspector General's exclusion list, and/or other similar national registries and databases. In some embodiments, the HHA ECV-AN Database 345 comprises data with regards to ECV eligibility by being regularly updated with data from the State Level Registries and Databases 360 and the Federal Level Registries and Databases 365.

The verification code looks up the HHA Patient 310 in the HHA Patient Fingerprint Database 350 to verify that the individual at the location of the ECV is actually the HHA Patient 310 and that the HHA Patient 310 is eligible to receive the service. The HHA Patient's 310 eligibility to receive the service is verified by checking with the Centers for Medicare and Medicaid 380. In some embodiments, the HHA Patient Fingerprint Database 350 comprises data with regards to patient eligibility by being regularly updated with data from the Centers for Medicare and Medicaid 380.

In addition to verifying the ECV and patient, the verification code also verifies that the service and the location of the service are allowed by verifying with a product/service database 355. In some embodiments, this information is integrated with the Patient Fingerprint Database 350. If all the verifications check out, the HHA ECV 305 may then receive a notification that they may proceed with the performance of the product or service. If the HHA ECV 305 proceeds to perform the product or service without prior verification, the HHA may withhold payment for that particular product or service. Additionally, if the verification fails, the HHA may be notified, thus enabling the HHA to investigate or contact legal authorities. Doing so may result in the apprehension of the perpetrator of the potential fraudulent theft of Medicare, Medicaid, or private insurance monies.

In alternative embodiments, the server 320 and the verification apparatus 315 are integrated into a combined apparatus. The apparatus in this embodiment is similar to the Verification Apparatus 215 disclosed in FIG. 2.

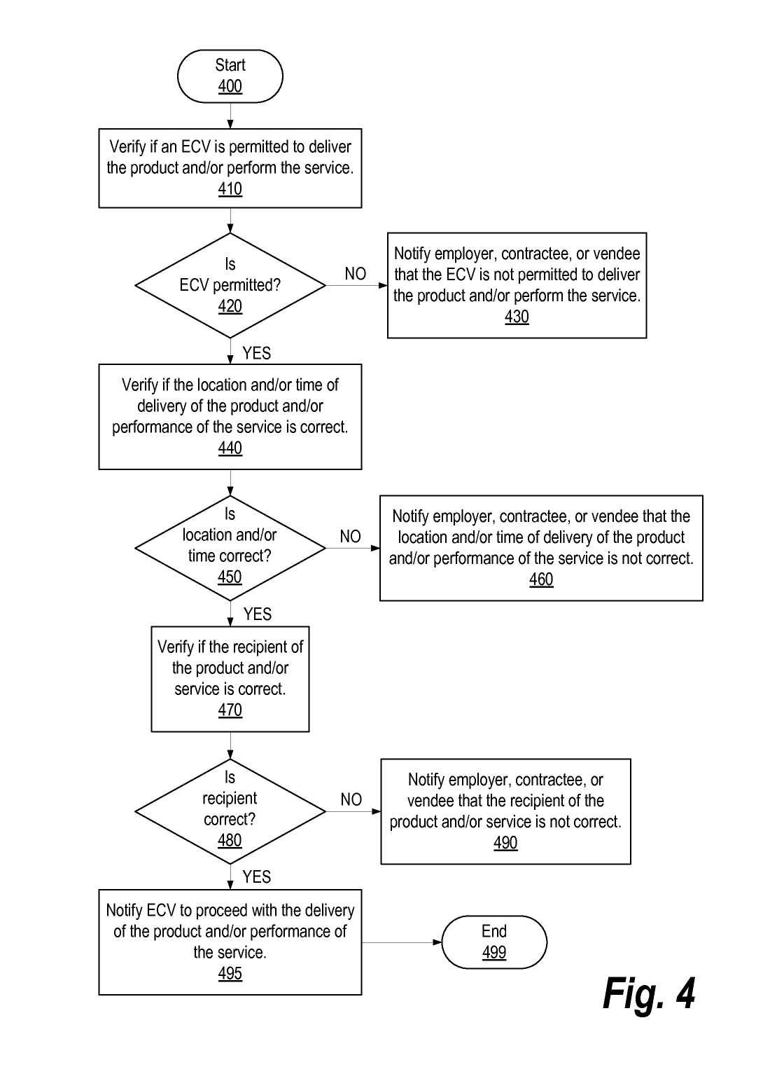

FIG. 4 is a block diagram illustrating a method for preventing fraud in a remote workforce environment, in accordance with some embodiments.

Processing begins at 400 whereupon, at block 410, a verification is conducted to see if an ECV is permitted to deliver the product and/or perform the service. In some embodiments, the method illustrated in FIG. 4 may be performed by one or more of the devices illustrated in FIGS. 1 to 3. Next, at decision block 420, if the ECV is not permitted to deliver the product and/or perform the service, decision 420 branches to the “no” branch where, at block 430, the employer, contractee, or vendee (the supervisor of the ECV) is notified that the ECV is not permitted to deliver the product and/or perform the service. If the ECV is permitted to deliver the product and/or perform the service, decision 420 branches to the “yes” branch where, at block 440, a verification is conducted to see if the location and/or time of delivery of the product and/or performance of the service is correct. Next, at decision block 450, if the location and/or time of delivery of the product and/or performance of the service is not correct, decision 450 branches to the “no” branch where, at block 460, the employer, contractee, or vendee is notified that the location and/or time of delivery of the product and/or performance of the service is not correct. If the location and/or time of delivery of the product and/or performance of the service is correct, decision 450 branches to the “yes” branch where, at block 470, a verification is conducted to see if the recipient of the product and/or service is correct. Next, at decision block 480, if the recipient of the product or service is not correct, decision 480 branches to the “no” branch where, at block 490, the employer, contractee, or vendee is notified that the recipient of the product and/or service is not correct. If the recipient of the product and/or service is correct, decision 480 branches to the “yes” branch where, at block 495, notification is given to the ECV to proceed with the delivery of the product and/or performance of the service. Processing subsequently ends at 499. The particular order of the verifications is not important, just as long as the verifications at block 410, 440, and 470 are conducted prior to giving notification to proceed to the ECV.

The health care industry is not the only environment or industry where the fraud prevention apparatus may be utilized. Any environment that requires or utilizes a remote workforce may benefit from the invention's personnel, location, and product/procedure verification.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

The benefits and advantages that may be provided by the present invention have been described above with regard to specific embodiments. These benefits and advantages, and any elements or limitations that may cause them to occur or to become more pronounced are not to be construed as critical, required, or essential features of any or all of the claims. As used herein, the terms “comprises,” “comprising,” or any other variations thereof, are intended to be interpreted as non-exclusively including the elements or limitations which follow those terms. Accordingly, a system, method, or other embodiment that comprises a set of elements is not limited to only those elements, and may include other elements not expressly listed or inherent to the claimed embodiment.

While the present invention has been described with reference to particular embodiments, it should be understood that the embodiments are illustrative and that the scope of the invention is not limited to these embodiments. Many variations, modifications, additions, and improvements to the embodiments described above are possible. It is contemplated that these variations, modifications, additions, and improvements fall within the scope of the invention as detailed within the following claims.

1. An apparatus for preventing fraud in a remote workforce environment, the apparatus comprising:
one or more processors;
system memory coupled to the one or more processors;
one or more non-transitory memory units coupled to the one or more processors; and
verification code stored on the one or more non-transitory memory units that when executed by the one or more processors are configured to perform a method, comprising:
verifying if an ECV is permitted to deliver a product and/or perform a service; and if it is determined that the ECV is not permitted to deliver the product and/or perform the service, then notifying a supervisor of the ECV that the ECV is not permitted to deliver the product and/or perform the service; and
verifying if recipient of the product and/or service is correct; and if it is determined that the recipient of the product and/or service is not correct, then notifying the supervisor of the ECV that the recipient of the product and/or service is not correct.

2. The apparatus of claim 1, wherein the verification code stored on the one or more non-transitory memory units that when executed by the one or more processors are configured to perform a method, further comprising:
if it is determined that:
the ECV is permitted to deliver the product and/or perform the service and the recipient of the product and/or service is correct, then notifying the ECV to proceed with the delivery of the product and/or service.

3. The apparatus of claim 1, wherein the verification code stored on the one or more non-transitory memory units that when executed by the one or more processors are configured to perform a method, further comprising:
verifying if location and/or time of delivery of the product and/or performance of the service is correct; and if it is determined that the location and/or time of delivery of the product and/or performance of the service is not correct, then notifying the supervisor of the ECV that the location and/or time of delivery of the product and/or performance of the service is not correct; and
if it is determined that:
the ECV is permitted to deliver the product and/or perform the service, the recipient of the product and/or service is correct, and
the location and/or time of delivery of the product and/or performance of the service is correct, then notifying the ECV to proceed with the delivery of the product and/or performance of the service.

4. The apparatus of claim 1, wherein verifying if the ECV is permitted to deliver a product and/or perform a service comprises:
obtaining identification of the ECV; and
using the identification of the ECV to verify the ECV's authorization to deliver the product and/or perform the service by looking up the ECV in an ECV-A/V database.

5. The apparatus of claim 4, wherein obtaining identification of the ECV comprises obtaining a fingerprint from the ECV and using the fingerprint to identify the ECV from an ECV fingerprint database.

6. The apparatus of claim 1, wherein verifying if the recipient of the product and/or service is correct comprises:
obtaining identification of the recipient; and
using the identification of the recipient to verify the recipient's eligibility to receive the product and/or service by checking with the Centers for Medicare and Medicaid.

7. The apparatus of claim 6, wherein verifying if the recipient of the product and/or service is correct further comprises using the identification of the recipient to verify the recipient's eligibility to receive the product and/or service by looking up the recipient in a product/service database.

8. The apparatus of claim 6, wherein obtaining identification of the recipient comprises obtaining a fingerprint from the recipient and using the fingerprint to identify the recipient from a recipient fingerprint database.

9. The apparatus of claim 1, further comprising one or more remote verification apparatuses in communication with the apparatus.

10. The apparatus of claim 9, wherein the one or more remote verification apparatuses and the apparatus are one in the same.

11. A method for preventing fraud in a remote workforce environment, the method comprising:
an apparatus, which includes one or more processors, system memory coupled to the one or more processors, one or more non-transitory memory units coupled to the one or more processors, and verification code stored on the one or more non-transitory memory units;
verifying if an ECV is permitted to deliver a product and/or perform a service; and if it is determined that the ECV is not permitted to deliver the product and/or perform the service, then notifying a supervisor of the ECV that the ECV is not permitted to deliver the product and/or perform the service; and
verifying if recipient of the product and/or service is correct; and if it is determined that the recipient of the product and/or service is not correct, then notifying the supervisor of the ECV that the recipient of the product and/or service is not correct.

12. The method of claim 11, the method further comprising:
if it is determined that:
the ECV is permitted to deliver the product and/or perform the service and the recipient of the product and/or service is correct, then notifying the ECV to proceed with the delivery of the product and/or service.

13. The method of claim 11, the method further comprising:
verifying if location and/or time of delivery of the product and/or performance of the service is correct; and if it is determined that the location and/or time of delivery of the product and/or performance of the service is not correct, then notifying the supervisor of the ECV that the location and/or time of delivery of the product and/or performance of the service is not correct; and
if it is determined that:
the ECV is permitted to deliver the product and/or perform the service, the recipient of the product and/or service is correct, and
the location and/or time of delivery of the product and/or performance of the service is correct, then notifying the ECV to proceed with the delivery of the product and/or performance of the service.

14. The method of claim 11, wherein verifying if the ECV is permitted to deliver a product and/or perform a service comprises:
obtaining identification of the ECV; and
using the identification of the ECV to verify the ECV's authorization to deliver the product and/or perform the service by looking up the ECV in an ECV-A/V database.

15. The method of claim 14, wherein obtaining identification of the ECV comprises obtaining a fingerprint from the ECV and using the fingerprint to identify the ECV from an ECV fingerprint database.

16. The method of claim 11, wherein verifying if the recipient of the product and/or service is correct comprises:
obtaining identification of the recipient; and
using the identification of the recipient to verify the recipient's eligibility to receive the product and/or service by checking with the Centers for Medicare and Medicaid.

17. The method of claim 16, wherein verifying if the recipient of the product and/or service is correct further comprises using the identification of the recipient to verify the recipient's eligibility to receive the product and/or service by looking up the recipient in a product/service database.

18. The method of claim 16, wherein obtaining identification of the recipient comprises obtaining a fingerprint from the recipient and using the fingerprint to identify the recipient from a recipient fingerprint database.

19. The method of claim 11, further comprising one or more remote verification apparatuses in communication with the apparatus.

20. The method of claim 19, wherein the one or more remote verification apparatuses and the apparatus are one in the same.
